(19) United States
(12) Patent Application Publication
(10) Pub. No.: US 2026/0118229 A1
(43) Pub. Date: Apr. 30, 2026

(54) DEPTH-LIMITING DEVICE FOR A GRAB SAMPLER AND A GRAB SAMPLER INCLUDING THE SAME

(71) Applicant: Battelle Memorial Institute, Columbus, OH (US)

(72) Inventor: Caitlyn FARRAGHER, Boston, MA (US)

(21) Appl. No.: 19/363,734

(22) Filed: Oct. 21, 2025

Related U.S. Application Data
(60) Provisional application No. 63/711,814, filed on Oct. 25, 2024.

(51) Int. Cl. G01N 1/08

(52) U.S. Cl. CPC G01N 1/08; G01N 2001/085

(57) ABSTRACT

A depth-limiting device for a grab sampler including at least one bucket supported by a frame having a top and a bottom. The depth-limiting device including: a base having a foundation with an opening therethrough for receiving at least a portion of the at least one bucket therethrough, and at least one bracket coupled to the base, at least a portion of the bracket extending upwardly from a top surface of the base. The bracket is configured for coupling to the frame of the grab sampler with a bottom of the base being disposed below the bottom of the frame by a distance defined by the at least one bracket.

### CROSS-REFERENCE TO RELATED APPLICATIONS

The present application claims the benefit of the filing date of U.S. Provisional Application Ser. No. 63/711,814, filed, Oct. 25, 2024, the entire teachings of which are hereby incorporated herein by reference.

### FIELD

The present disclosure relates to grab samplers, and, more particularly, to a depth-limiting device for a grab sample and a grab sampler including the same.

### BACKGROUND

A grab sampler is a well-known device used for taking a sample of a sediment from the floor of an underwater environment, e.g., a sea floor, lakebed, riverbed, etc. A variety of grab sampler variations are known. Known grab samplers include, for example, Van Veen grab samplers and Young modified Van Veen grab samplers.

A grab sampler may include one or more buckets, e.g., known clamshell buckets, coupled to a frame. Each bucket includes a first side and second side. The bucket has an open position wherein the first and second sides are rotated away from each other and a closed position wherein the first and second sides are rotated toward each other. The bucket moves from the open position to the closed position when the grab sample reaches the floor of the underwater environment to capture and retain sediment in the bucket.

FIGS. 1A-1D illustrate successive steps in operation of one example of a known Young modified grab sampler 100 for taking a sediment sample from sea floor. The illustrated example includes a single bucket 102 having a first side 101 and a second side 103 supported by a frame 104. The grab sampler 100 may be lowered by a cable 106 into water 108 with the bucket in an open position, i.e. the first 101 and second 103 are rotated away from each other, as shown in FIG. 1A. When the grab sampler 100 contacts the sea floor 110, the weight of the grab sampler 100 causes the bucket 102 to dig into the sea floor 110, as shown in FIG. 1B, and the cable 106 goes slack thereby unlocking a linkage 112 that holds the bucket 102 in the open position.

The bucket then moves to the closed position with the first 101 and second sides 103 rotated toward each other, as shown in FIG. 1C, capturing and retaining sediment from the sea floor 110. In some embodiments, for example, the bucket may collect approximately the top 13 centimeters (cm) of sediment. The bucket 102 stays in the closed position as the grab sampler 100 is lifted by the cable 106, as shown in FIG. 1D.

The grab sampler 100 is returned to the surface 114, e.g., onboard a ship, where the grab sampler 100 is positioned over a collection container. A user then extracts one or more samples of the sediment from the bucket 102, e.g., by opening a lid on the top of the bucket 102 or moving the bucket from the closed position to the open position to access the sediment therein.

### BRIEF DESCRIPTION OF THE DRAWINGS

For a better understanding of the present invention, together with other objects, features and advantages, reference should be made to the following detailed description which should be read in conjunction with the accompanying figures, wherein:

FIGS. 1A-1D are successive views of a prior art grab sampler showing operation of the grab sampler in taking a sediment sample from a sea floor.

FIG. 2 is a side perspective view of one example of a known Young modified Van Veen grab sampler.

FIG. 3 is a top perspective view of one example embodiment of a depth-limiting device consistent with the present disclosure.

FIG. 4 is a top perspective view of the depth-limiting device shown in FIG. 3 coupled to the grab sampler shown in FIG. 2.

FIG. 5 is an outside close-up view FIG. 4 showing of a connection between a bracket and a mounting plate of the depth-limiting device to the frame of the grab sampler.

FIG. 6 is an inside close-up view FIG. 4 showing of a connection between a bracket and a mounting plate of the depth-limiting device to the frame of the grab sampler.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

In the operation of grab samplers, it has been discovered that when taking samples with softer and/or silty sediment, the bucket may sink into the sediment causing the grab sampler to over penetrate. When the target sediment for sampling is above the penetration depth of the bucket the bucket may not sufficiently collect the target sediment. For example, in some instances the target sediment may be the top six inches of the sea floor and when the sediment is soft and or silty, the bucket may penetrate beyond six inches into the sediment. Unfortunately, over penetration of the grab sampler cannot be readily determined during collection of samples.

A depth-limiting device consistent with the present disclosure may restrict over penetration of a grab sampler and may include a base including a foundation having an opening therethrough for receiving at least a portion of at least one grab sampler bucket therethrough and at least one bracket for coupling the depth-limiting device to the grab sampler. The device may be coupled to the grab sampler by the at least one bracket with a bottom of the base being disposed below a bottom surface of a frame of the grab sampler by a distance defined by the at least one bracket. The foundation is configured to limit penetration of the grab sampler into the sediment to allow for collection of target sediment in soft and/or silty sediment.

In some embodiments, the foundation may include a mesh steel to allow the grab sampler and the device to pass through the water without alleviating pressure on the cable and prematurely unlocking the linkage the maintains the bucket in a closed position, while also maintaining a surface area to limit penetration into the sediment. In some embodiments, the depth of penetration may be adjusted by adjustment of position of the bracket relative to the frame. The device may be easily and quickly coupled to a known grab sampler using the bracket(s).

For ease of explanation only, a depth-limiting device consistent with the present disclosure may be shown and described herein for use in connection with a particular Young modified Van Veen grab sampler including two buckets. It is to be understood, however, that a grab sampler consistent with the present disclosure may be portable, may be configured to for use with a wide variety of grab samplers including any number of buckets, and may be provided in a variety of sizes, shapes and configurations, e.g., depending on the configuration of the grab with which it is used and/or the sediment from which samples are to be taken. The example embodiments shown and described herein are thus provided by way of illustration, not limitation.

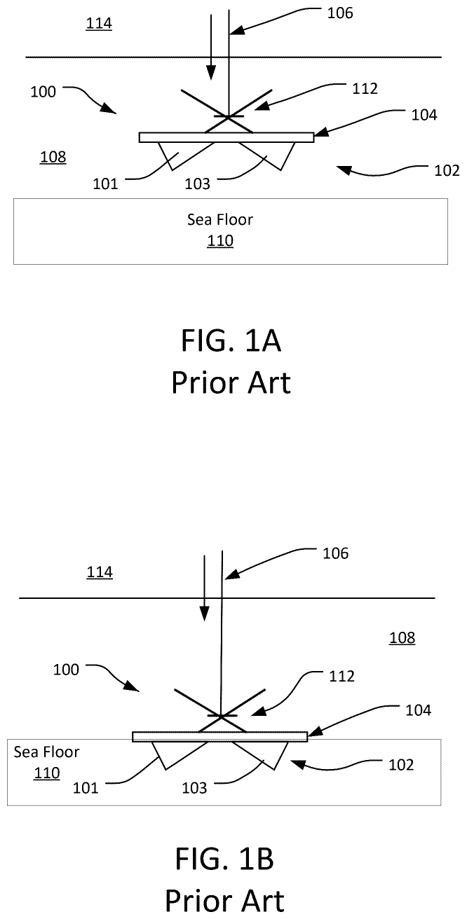

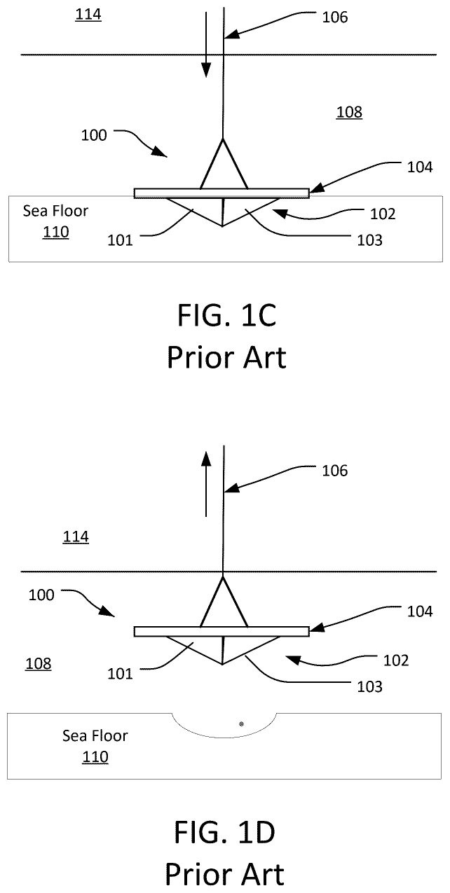

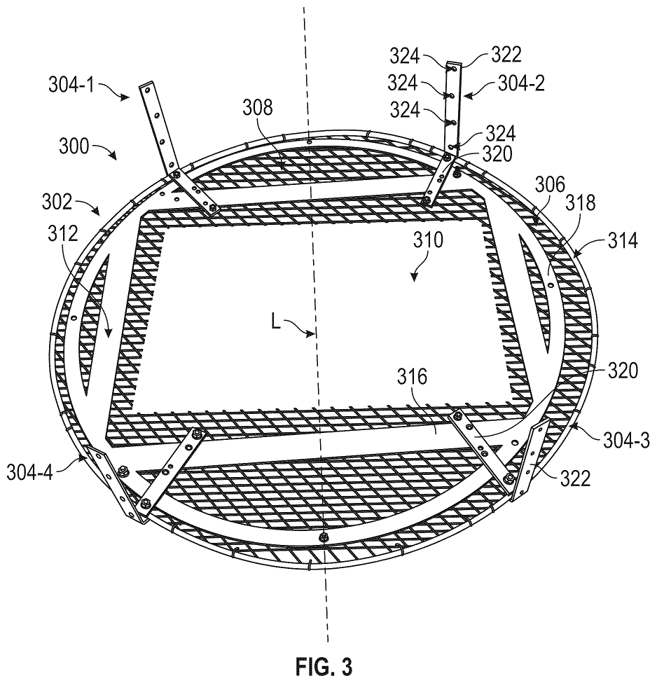

FIG. 2 is a side perspective view of one example of a known Young modified Van Veen grab sampler 200. In general, the grab sampler 200 operates as described above in connection with FIGS. 1A-1D. The sampler includes a stainless-steel frame 104a supporting two hinged buckets 102-1, 102-2. The frame 104a has a top and a bottom and each of the buckets 102-1, 102-2 has a first and second side coupled to a hinge 400 (FIG. 4). In the illustrated example embodiment, the frame 104a is generally circular.

The buckets 102-1, 102-2 are operatively to a cable 106a by a linkage 112a configured to retain the buckets 102-1, 102-2 in an open position as the grab sampler 200 is lowered into the water. The linkage 112a unlocks to allow the buckets 102-1, 102-2 to close when the grab sampler 200 contacts the sea floor. As the buckets 102-1, 102-2 close they collect sediment from the sea floor. The buckets 102-1, 102-2 remain closed as the grab sampler 200 is raised from the water until the grab sampler 200 is returned to the surface. Samples of the sediment then be removed from the buckets 102-1, 102-2.

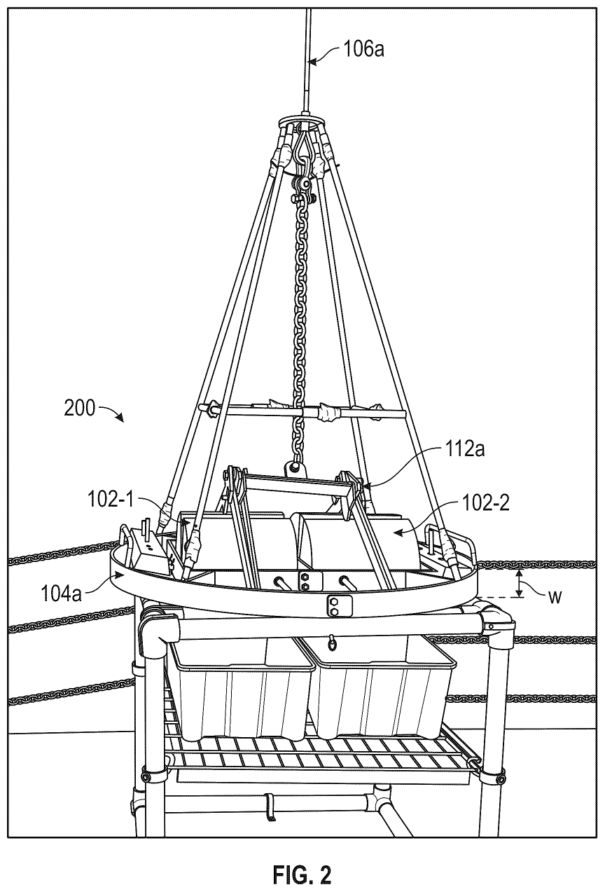

FIG. 3 is a top perspective view of one example embodiment of a depth-limiting device 300 consistent with the present disclosure. The illustrated example embodiment includes a base 302 and four brackets 304-1, 304-2, 304-3, 304-4. The brackets 304-1, 304-2, 304-3, 304-4 are coupled to the base 302 and at least a portion of each of the brackets 304-1, 304-2, 304-3, 304-4 extends upwardly from a top surface 306 of the base 302 for coupling the depth-limiting device 300 to the frame 104a of the grab sampler 200.

The illustrated base 302 includes a foundation 308 having an opening 310 therethrough, at least one support member 312, and a border 314. In the illustrated example embodiment, the foundation 308 is constructed from a single sheet of mesh steel and is generally circular with a radius substantially the same as the radius of the frame 104a of the grab sampler 200. The mesh size of the mesh steel may depend on the application and may be selected to allow water to flow through the foundation 308 to avoid prematurely unlocking the linkage 112a on the grab sampler 200 as the grab sampler 200 with the device 300 attached thereto is lowered into the water, while also providing sufficient surface area to limit penetration of the grab sampler 200 into the sediment. It is to be understood that the foundation 308 may be provided in a variety of configurations. For example, the foundation 308 may be constructed from one or more sheets of mesh or non-mesh material, may be a mesh material having different mesh sizes, may be constructed from material other than steel, e.g., plastic, and may be configured in any geometric shape and size, etc.

In the illustrated example, the opening 310 in the foundation 308 is generally rectangular and is positioned to align with the bottoms of the buckets 102-1, 102-2 when the device 300 is attached to the grab sampler 200. At least a portion of the buckets 102-1, 102-2 may pass through the opening 310 for collecting sediment samples during operation. The opening 310 may be configured in any shape and size depending on the shape and size of the bucket(s) of the grab sampler 200.

In the illustrated example embodiment, the support member 312 is constructed from matching top and bottom layers of sheet steel and the foundation 308 is sandwiched between the layers to provide structural support for the foundation 308. The support member 312 includes a first portion 316 extending around the perimeter of the opening 310 and a second portion 318 extending around a perimeter of the foundation 308. The first portion 316 is generally rectangular corresponding to the shape of the opening 310 and the second portion 318 is generally circular corresponding to the shape of the perimeter of the foundation 308. The support member 312 may be provided in a variety of configurations depending on the application and the locations of desired structural support the foundation 308.

The border 314 is coupled to and extends around the perimeter of the foundation 308 to protect a user from sharp edges of the foundation 308. In the illustrated example embodiment, the border 314 is a rubber member and is coupled to the foundation 308 using cable ties. The border 314 may be provided in a variety of configurations and shapes depending on the configuration of the foundation 308 and may be constructed from a single component or multiple components.

Each of the brackets 304-1, 304-2, 304-3, 304-4 in the illustrated example embodiment is a generally L-shaped flat steel members with a first leg 320 and a second leg 322. The first leg 320 is positioned disposed on a top surface 306 of the base 302 and secured to the foundation 308 by fasteners. The second leg 322 extends upwardly from the first leg 320 adjacent the perimeter of the of the foundation 308 where the border 314 is attached to the foundation 308. In the illustrated example, the second leg 322 extends upwardly from the first leg 320 adjacent the perimeter of the of the foundation 308 at a position radially outwardly from the border 314. The second leg 322 has a series of mounting holes 324 spaced along the length of the second leg 322. The mounting holes 324 may be spaced by a distance greater than a width W (FIG. 2) of the frame 104a by an amount sufficient to hold the frame 104a between consecutive ones of the mounting holes 324 as described herein.

First 304-1 and second 304-2 ones of the brackets are positioned at about +15 degrees from a center line of the base 302 and −15 degrees from a center line L of the base 302, respectively at a first side of the opening 310. Third 304-3 and fourth 304-4 ones of the brackets are positioned at about +15 degrees from a center line of the base 302 and −15 degrees from a center line of the base 302, respectively at a second side of the opening 310. This configuration allows for facile assembly of the grab sampler 200 shown in FIG. 2 with the brackets 304-1, 304-2, 304-3, 304-4 in positions that do not interfere with features of the grab sampler 200. It is to be understood, however, that any number of brackets may be provided in a depth-limiting device consistent with the present disclosure, and the brackets may be placed in any position for mounting the device to a grab sampler

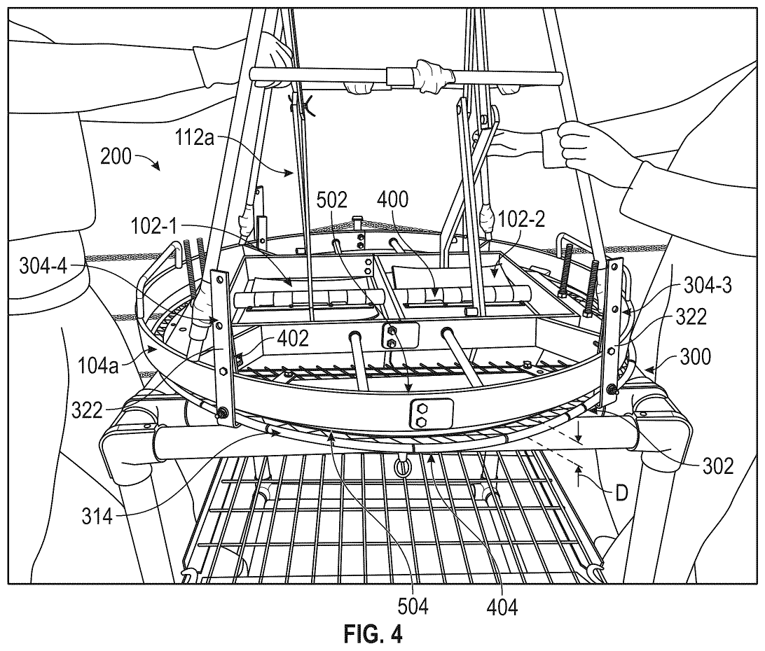

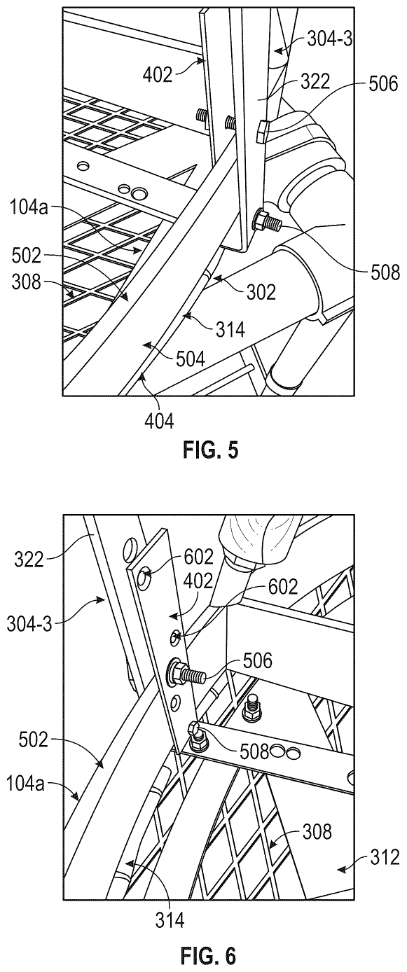

As shown in FIGS. 4-6, the depth-limiting device 300 is coupled to the grab sampler 200 by placing the device 300 under the grab sampler 200 with the second legs 322 of the brackets 304-1, 304-2, 304-3, 304-4 extending upwardly from the base 302 of the device 300 with an interior surface of each second leg 322 in opposed facing relationship to an exterior surface of the frame 104a. The frame 104a is then captured between the interior surface of each second leg 322 an exterior surface of an associated mounting plate 402. The mounting plate 402 has holes therethrough, e.g., holes 602 (FIG. 6) that align with any two adjacent mounting holes 324 on the second leg 322 of the associated bracket 304-1, 304-2, 304-3, 304-4.

The frame 104a is aligned with the device 300 so that the mounting holes 324 in the second leg 322 and the aligned holes 602 the mounting plate 402 are located at the top 502 and bottom 504 of the frame 104a. The mounting plate 402 is then coupled to the second leg 322 by fasteners 506, 508 extending through the mounting holes 324 and the aligned holes, e.g., holes 602, in the mounting plate 402, as shown, so that the fasteners 506, 508 are positioned at the top 502 and bottom 504 of the frame 104a. This holds the frame 104a in a fixed position between the second leg 322 of each bracket 304-1, 304-2, 304-3, 304-4 and its associated mounting plate 402 with the bottom 404 of the base 302 disposed at a fixed distance D (FIG. 4) from the bottom 504 of the frame 104a.

The distance D is inversely related to the depth of penetration of the grab sampler 200. The depth of penetration may thus be increased by reducing the distance D and increased by increasing the distance D. The distance D may be adjusted by placing frame 104a between selected ones of the mounting holes 324 in the second leg 322 of each bracket 304-1, 304-2, 304-3 and fastening the mounting plate 402 to the second leg 322 of the bracket 304-1, 304-2, 304-3 so that the frame 104a is captured between the selected ones of the mounting holes 324 in the second leg 322 of each bracket 304-1, 304-2, 304-3.

Although the illustrated example embodiment includes L-shaped brackets 304-1, 304-2, 304-3, 304-4 for mounting the depth-limiting device 300 to the grab sampler 200, other configurations may be used for coupling the device 300 to the sampler 200 in a way that rigidly maintains the distance D between the bottom 404 of the base 302 and the bottom 504 of the frame 104a. For example, the bracket need not be L-shaped and may be a single flat sheet of steel coupled to the base 302 and extending upwardly from the base 302.

According to one aspect of the present disclosure, there is thus provided a depth-limiting device for a grab sampler including at least one bucket supported by a frame having a top and a bottom. The depth-limiting device includes a base including a foundation having an opening therethrough for receiving at least a portion of the at least one bucket therethrough; and at least one bracket coupled to the base, at least a portion of the at least one bracket extending upwardly from a top surface of the base. The at least one bracket is configured for coupling to the frame with a bottom of the base being disposed below the bottom of the frame by a distance defined by the at least one bracket.

According to another aspect of the disclosure, there is provided a depth-limiting device for a grab sampler including at least one bucket supported by a frame having a top and a bottom. The depth-limiting device includes: a base including a foundation including a mesh material and having an opening therethrough for receiving at least a portion of the at least one bucket therethrough, a support member having first and second sides, the support member being coupled to the foundation with the foundation being disposed between the first and second sides, a border positioned around at least a portion of the perimeter of the foundation, at least one bracket coupled to the base, at least a portion of the at least one bracket extending upwardly from a top surface of the base, the at least one bracket having a series of mounting holes therethrough; and a mounting plate. The at least one bracket is configured for coupling to the frame with the frame being captured between the mounting plate and the at least one bracket and between adjacent ones of the mounting holes with a bottom of the base being disposed below the bottom of the frame by a distance defined by the at least one bracket.

According to another aspect of the disclosure, there is provided a grab sampler including: a frame having a top and a bottom, and at least one bucket supported by the frame, the at least one bucket having first and second sides and having an open position wherein the first and second sides are rotated away from each other and a closed position wherein the first and second sides are rotated toward each other to retain sediment in the bucket; and a depth-limiting device coupled to the frame. The depth-limiting device includes a base including a foundation having an opening therethrough for receiving at least a portion of the at least one bucket therethrough, and at least one bracket coupled to the base, at least a portion of the at least one bracket extending upwardly from a top surface of the base. The at least one bracket is coupled to the frame with a bottom of the base being disposed below the bottom of the frame by a distance defined by the at least one bracket.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein.

It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The term “coupled” as used herein refers to any connection, coupling, link. Components described herein as “coupled” may be directly coupled to one another or may be indirectly coupled through intermediate components.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

The terms “comprising”, “including” and “having” are intended to be inclusive and mean that there may be additional elements other than the listed elements.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Spatially relative terms, such as “beneath,” below,” upper,”. “lower,” “above” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

What is claimed is:

1. A depth-limiting device for a grab sampler including at least one bucket supported by a frame having a top and a bottom, the depth-limiting device comprising:
a base comprising a foundation having an opening therethrough for receiving at least a portion of the at least one bucket therethrough; and
at least one bracket coupled to the base, at least a portion of the at least one bracket extending upwardly from a top surface of the base,
the at least one bracket configured for coupling to the frame with a bottom of the base being disposed below the bottom of the frame by a distance defined by the at least one bracket.

2. The depth-limiting device of claim 1, wherein the distance is adjustable by adjustment of a position of the at least one bracket to the frame.

3. The depth-limiting device of claim 1, wherein depth-limiting device further comprises a mounting plate and the frame is captured between the mounting plate and the at least one bracket.

4. The depth-limiting device of claim 3, wherein the at least one bracket includes a series of mounting holes and the frame is captured between the mounting plate and the at least one bracket and between adjacent ones of the mounting holes.

5. The depth-limiting device of claim 1, wherein the at least one bracket is generally L-shaped.

6. The depth-limiting device of claim 1, wherein the foundation is configured to allow water to flow therethrough.

7. The depth-limiting device of claim 1, wherein the foundation comprises a mesh material.

8. The depth-limiting device of claim 1, wherein base further comprises at least one support member positioned around at least a portion of a perimeter of the opening.

9. The depth-limiting device of claim 1, wherein base further comprises at least one border positioned around at least a portion of the perimeter of the foundation.

10. A depth-limiting device for a grab sampler including at least one bucket supported by a frame having a top and a bottom, the depth-limiting device comprising:
a base comprising
a foundation comprising a mesh material and having an opening therethrough for receiving at least a portion of the at least one bucket therethrough,
a support member having first and second sides, the support member being coupled to the foundation with the foundation being disposed between the first and second sides, and
a border positioned around at least a portion of the perimeter of the foundation;
at least one bracket coupled to the base, at least a portion of the at least one bracket extending upwardly from a top surface of the base, the at least one bracket having a series of mounting holes therethrough; and
a mounting plate,
the at least one bracket configured for coupling to the frame with the frame being captured between the mounting plate and the at least one bracket and between adjacent ones of the mounting holes with a bottom of the base being disposed below the bottom of the frame by a distance defined by the at least one bracket.

11. The depth-limiting device of claim 10, wherein the distance is adjustable by adjustment of a position of the at least one bracket to the frame.

12. A grab sampler comprising:
a frame having a top and a bottom;
at least one bucket supported by the frame, the at least one bucket having first and second sides and having an open position wherein the first and second sides are rotated away from each other and a closed position wherein the first and second sides are rotated toward each other to retain sediment in the bucket; and
a depth-limiting device coupled to the frame, the depth-limiting device comprising
a base comprising a foundation having an opening therethrough for receiving at least a portion of the at least one bucket therethrough, and
at least one bracket coupled to the base, at least a portion of the at least one bracket extending upwardly from a top surface of the base,
the at least one bracket being coupled to the frame with a bottom of the base being disposed below the bottom of the frame by a distance defined by the at least one bracket.

13. The grab sampler of claim 12, wherein the distance is adjustable by adjustment of a position of the at least one bracket to the frame.

14. The grab sampler of claim 12, wherein depth-limiting device further comprises a mounting plate and the frame is captured between the mounting plate and the at least one bracket.

15. The grab sampler of claim 14, wherein the at least one bracket includes a series of mounting holes and the frame is captured between the mounting plate and the at least one bracket and between adjacent ones of the mounting holes.

16. The grab sampler of claim 12, wherein the at least one bracket is generally L-shaped.

17. The grab sampler of claim 12, wherein the foundation is configured to allow water to flow therethrough.

18. The grab sampler of claim 12, wherein the foundation comprises a mesh material.

19. The grab sampler of claim 12, wherein base further comprises at least one support member positioned around at least a portion of a perimeter of the opening.

20. The grab sampler of claim 12, wherein base further comprises at least one border positioned around at least a portion of the perimeter of the foundation.
